(19) United States
(12) Patent Application Publication
(10) Pub. No.: US 2008/0256733 A1
(43) Pub. Date: Oct. 23, 2008

(54) Gary's paint brush

(76) Inventor: Gary M. Brown, St. Louis, MO (US)

Correspondence Address: Gary M Brown, 2847 Abner Place, St. Louis, MO, 63120, US

(21) Appl. No.: 11/788,154

(22) Filed: Apr. 19, 2007

(51) Int. Cl. B25G 1/04; A46B 5/00

(52) U.S. Cl. 15/144.3; 15/104.001; 15/143.1

(57) ABSTRACT

Gary's Paint Brush has a ¾″ screw hole on the handle. This will allow a painter to screw a paint brush onto an extension pole. The painter will then be able to paint in difficult areas without a ladder.

### BACKGROUND

A painting professional in the industry for many years, I have always found it difficult to reach corners on high stairways, tall ceilings and around fixtures. It was sometimes difficult and dangerous to use a ladder to reach these areas. I could never complete the high areas of a ceiling with a roller brush, so I would tape a paint brush onto an extension pole to reach those areas. However, this way was never really strong nor stable enough while trying to complete the job professionally.

### DESCRIPTION

Gary's paint brush is a paint brush with a ¾″ screw hole on the handle, for a painter's extension pole.

It can be hand held or screwed onto a painter's extension pole. When connected to a pole, a paint up high without a ladder and with stability.

### DRAWINGS

FIG. 1.0: Drawing of “Gary's Paint Brush” with a view of the screw hole.

FIG. 2.0: Drawing of “Gary's Paint Brush” and how it screws onto the extension pole. The screw hole will be universal to fit all painter extension poles on the market.

FIG. 3.0: Drawing of “Gary's Paint Brush” and how it will fit the extension pole offering strength and stability, for interior or exterior projects.

FIG. 4.0: Drawing of styles and sizes that “Gary's Paint Brush” can be manufactured in.

FIG. 5.0: Drawing view of “Gary's Paint Brush” (shown with dimensions—as open).

FIG. 6.0: Side view of “Gary's Paint Brush” (metal band closed).

FIG. 7.0: “Gary's Paint Brush” shown in plan view (bottom).

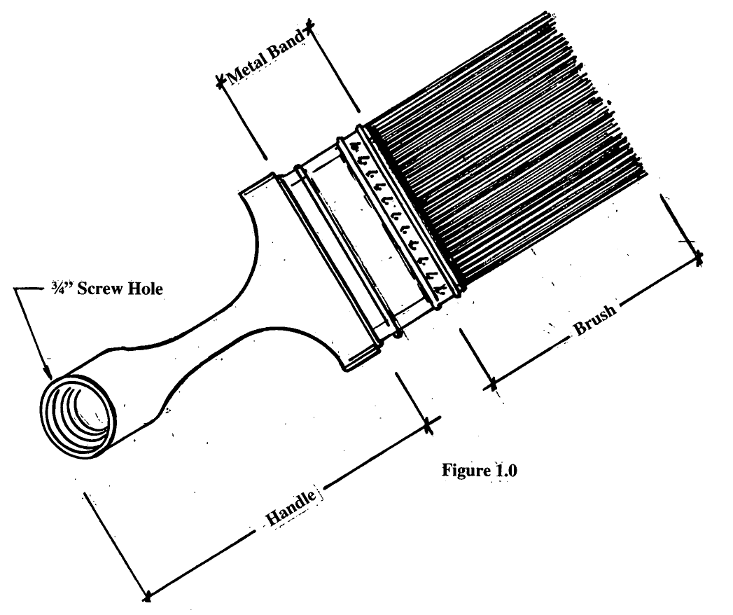

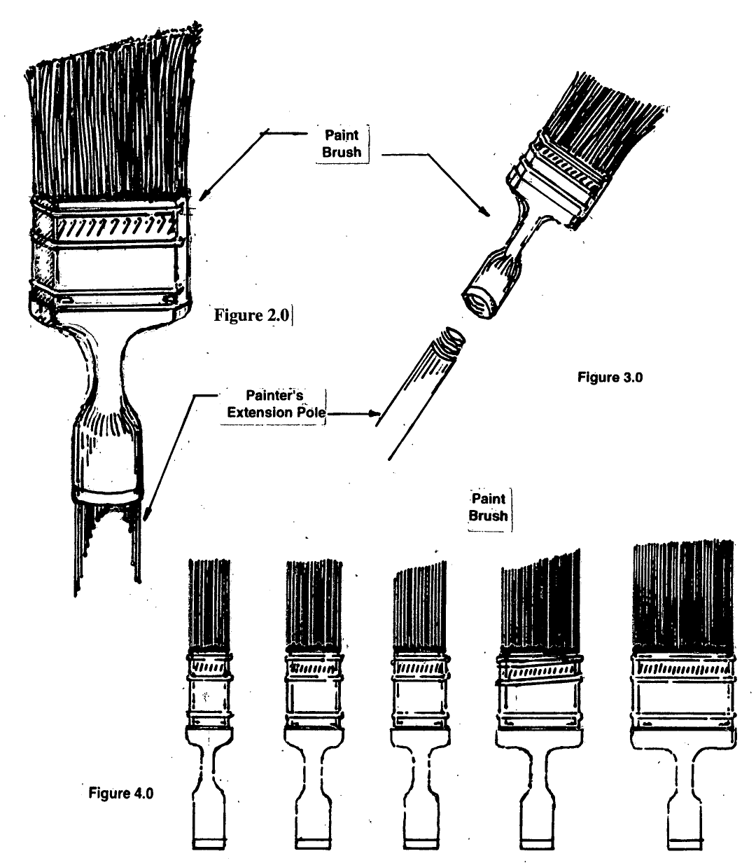

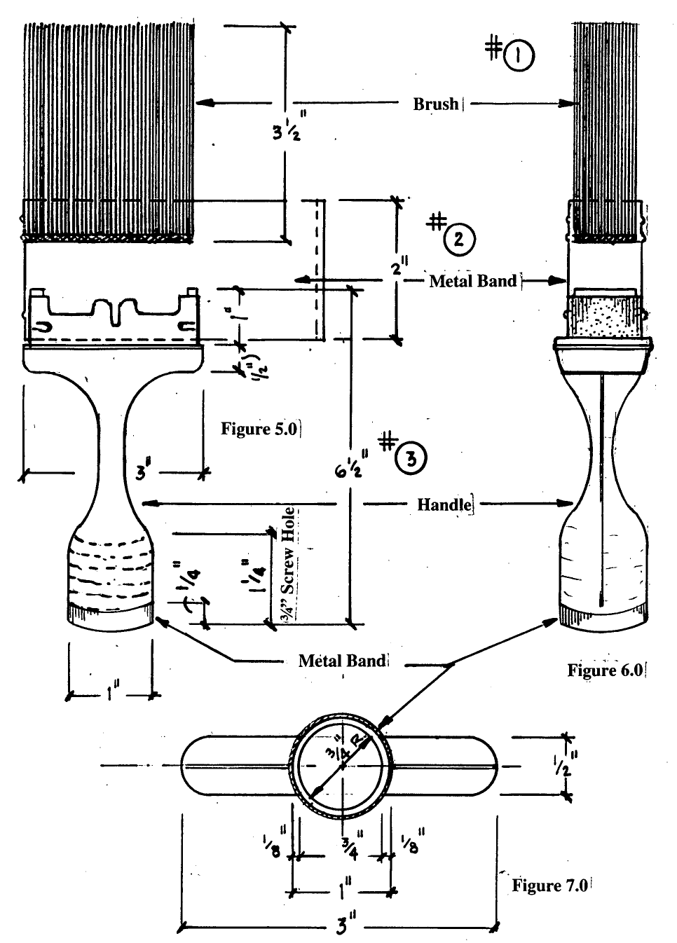

1. “Gary's Paint Brush” has a ¾″ screw hole at the end of the handle.

2. The screw hole will be universal to fit existing extension poles on the market.

3. “Gary's Paint Brush” will be made in various sizes and styles.
